(19) United States
(12) Patent Application Publication
(10) Pub. No.: US 2014/0241400 A1
(43) Pub. Date: Aug. 28, 2014

(54) ROTATING 3-WIRE RESISTANCE TEMPERATURE DETECTION EXCITATION CURRENT SOURCES AND METHOD

(71) Applicant: Linear Technology Corporation, Milpitas, CA (US)

(72) Inventors: Michael Keith Mayes, Nevada City, CA (US); Todd Stuart Kaplan, Grass Valley, CA (US); David Edward Bliss, Loomis, CA (US)

(73) Assignee: Linear Technology Corporation, Milpitas, CA (US)

(21) Appl. No.: 14/169,090

(22) Filed: Jan. 30, 2014

Related U.S. Application Data
(60) Provisional application No. 61/770,262, filed on Feb. 27, 2013.

(51) Int. Cl. G01K 7/16

(52) U.S. Cl. CPC G01K 7/16
USPC 374/185

(57) ABSTRACT

In a temperature sensing circuit, a method for measuring a resistance of a RTD device to sense temperature includes (a) connecting a first terminal of the RTD device to a first current source and connecting a second terminal of the RTD device to a second current source; (b) measuring a first voltage across the RTD device; (c) connecting the second terminal of the RTD device to the first current source and connecting the first terminal of the RTD device to the second current source; (d) measuring a second voltage across the RTD device; and (e) deriving the resistance of the RTD device based on the first voltage measurement and the second voltage measurement. The RTD device may be connected in series with a sense resistor to ground.

### CROSS REFERENCE TO RELATED APPLICATIONS

The present application is related to and claims priority of U.S. provisional patent application (“Copending Provisional Application”), Ser. No. 61/770,262, entitled “ROTATING 3-WIRE RESISTANCE TEMPERATURE DETECTION EXCITATION CURRENT SOURCES AND METHOD”, filed on Feb. 27, 2013. The Copending Provisional Application is hereby incorporated by reference in its entirety.

### BACKGROUND OF THE INVENTION

1. Field of the Invention

The present invention relates to circuits and methods for detecting temperature. In particular, the present invention relates to circuits and methods for detecting temperature using accurate resistance measurements.

2. Discussion of the Related Art

The resistance temperature detector (RTD) is a common temperature sensor that varies its resistance with temperature. FIG. 1 shows temperature sensing circuit 100, which includes 3-wire RTD 101 that is conventionally used for temperature sensing. As shown in FIG. 1, 3-wire RTD 101 (resistance R_{RTD}) is connected in series with sense resistor 106 (resistance Rₛₑₙₛₑ). Current sources 104a and 104b (providing currents I₁ and I₂) are connected respectively to first and second terminals of 3-wire RTD 101. The lead wires 102a and 102b that respectively connect current sources 104a and 104b to 3-wire RTD 101 each have parasitic resistance R_{L}. Thus, voltage V₁ across 3-wire RTD 101, including the parasitic lead resistors 102a and 102b, is given by:

V₁=I₁*(R_{RTD}+R_{L})−I₂*R_{L}

The voltage across sense resistor 106 is given by:

V₂=(I₁+I₂)*Rₛₑₙₛₑ

The resistance R_{RTD} can be obtained from these equations. These equations assume that resistance R_{L} in each of lead wires 102a and 102b are matched. An error in matching may result in an inaccurate temperature measurement. In order to alleviate the errors in matched resistance, the current sources 104a and 104b are also matched. Typically, in an integrated circuit implementation, current sources 104a and 104b are laid out in close proximity to allow the currents in current sources 104a and 104b to match. When properly matched, the currents I₁ and I₂ are equal and the resistances of lead wires 102a and 102b are each R_{L}, the resistance of R_{RTD} is given by, where the effects of RL are cancelled:

R_{RTD}=2*Rₛₑₙₛₑ*(V₁/V₂)

One drawback with the approach of temperature sensing circuit 100 is added complexity in testing, manufacturing and design of matched current sources.

### SUMMARY

The present invention provides, in a temperature sensing circuit, a method for measuring a resistance of a RTD device to sense temperature. The method includes (a) connecting a first terminal of the RTD device to a first current source and connecting a second terminal of the RTD device to a second current source; (b) measuring a first voltage across the RTD device; (c) connecting the second terminal of the RTD device to the first current source and connecting the first terminal of the RTD device to the second current source; (d) measuring a second voltage across the RTD device; and (e) deriving the resistance of the RTD device based on the first voltage measurement and the second voltage measurement. The RTD device may be connected in series with a sense resistor to ground.

To practice this method, according to one embodiment of the present invention, a temperature sensing circuit is provided, which includes (a) a first current source; (b) a second current source; and (c) a switch circuit configured, in a first configuration, to connect the first terminal of the RTD device to the first current source and the second terminal of the RTD device to the second current source, and configured, in a second configuration, to connect the second terminal of the RTD device to the first current source and the first terminal of the RTD device to the second current source. Each measurement of the resistance of the RTD device is made with two voltage measurements across the first and second terminals, in which the first voltage measurement has the switch circuit set in the first configuration and the second voltage measurement has the switch circuit set in the second configuration. The switch circuit may be implemented by pass transistors.

The present invention is better understood upon consideration of the detailed description below in conjunction with the accompanying drawings.

### BRIEF DESCRIPTION OF THE DRAWINGS

FIG. 1 shows temperature sensing circuit 100, which includes 3-wire RTD 101 that is conventionally used for temperature sensing.

FIGS. 2(a) and 2(b) show, respectively, switch circuit 201 of temperature sensing circuit 200 connecting current sources 104a and 104b to terminals of 3-wire RTD 101 in one polarity configuration and in an opposite polarity configuration.

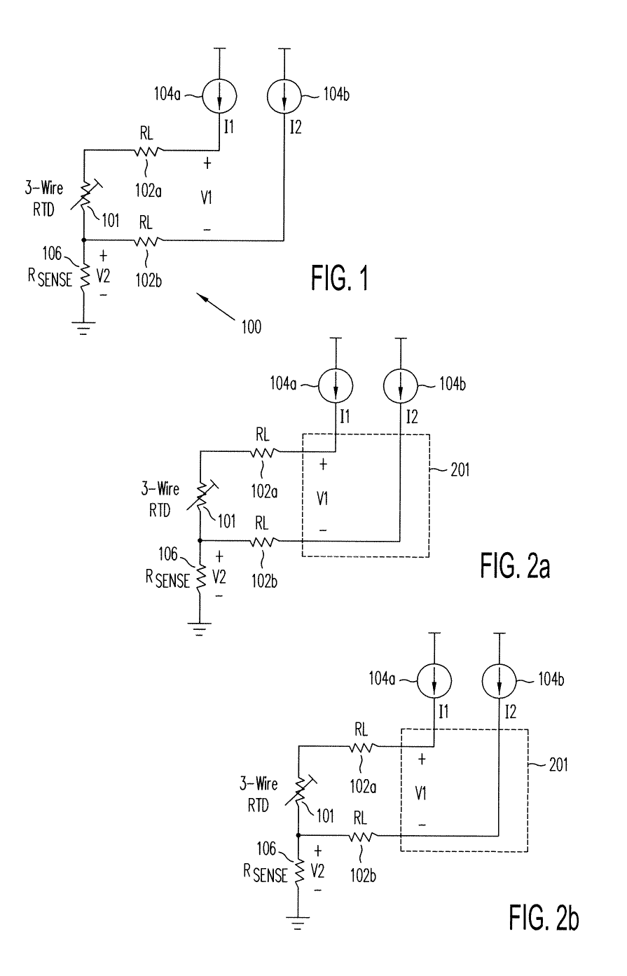

To facilitate comparison between figures, like elements may be provided like reference numerals across figures.

### DETAILED DESCRIPTION OF THE PREFERRED EMBODIMENTS

The present invention provides a method for temperature sensing using a 3-wire resistance temperature detection (RTD) device without requiring the sensing circuit to have matched current sources. According to one embodiment of the present invention, a switch circuit (e.g., switch circuit 201 of FIGS. 2(a) and 2(b) is provided which selectively connects each of current sources 104a and 104b to either terminal of 3-wire RTD 101. Switch circuit 201 may be implemented using four pass transistors. FIGS. 2(a) and 2(b) show, respectively, switch circuit 201 of temperature sensing circuit 200 connecting current sources 104a and 104b to terminals of 3-wire RTD 101 in one polarity configuration and in an opposite polarity configuration. As shown in FIG. 2(a), in the first polarity configuration, 3-wire RTD 101 (resistance R_{RTD}) is connected in series with a sense resistor 106 (resistance Rₛₑₙₛₑ is known). Current sources 104a and 104b (providing currents I₁ and I₂) are connected respectively to first and second terminals of 3-wire RTD 101. The lead wires 102a and 102b that connect current sources 104a and 104b each have parasitic resistance R_{L}. A first measurement of voltages V₁ and V₂, across 3-wire RTD 101 and sensing resistor 106, respectively, is made in this first polarity configuration. As shown in FIG. 2(b), in the second polarity configuration, current sources 104a and 104b (providing currents I₁ and I₂) are connected respectively to the second and the first terminals of 3-wire RTD 101. A second measurement of voltages V₁ and V₂, across 3-wire RTD 101 and sensing resistor 106, respectively, is made in this second polarity configuration.

The sum total of the voltages of V₁ across 3-wire RTD 101, measured in the two measurements, is given by:

V₁=(I₁+I₂)*R_{RTD}+(I₁+I₂)*R_{L}−(I₁+I₂)*R_{L}=(I₁+I₂)*R_{RTD}

The sum total of the voltages of V₂ across sense resistor 106, measured in the two measurements, is given by:

V₂=2*(I₁+I₂)*Rₛₑₙₛₑ

Using these equations, the resistance of R_{RTD} is given by:

R_{RTD}=2*Rₛₑₙₛₑ*(V₁/V₂)

The method of the present invention does not require currents I₁ and I₂ to be matched because, by making two measurements in opposite polarity configurations, the measured value of resistance R_{RTD} is independent of the values of currents I₁ and I₂.

The detailed description above is provided to illustrate specific embodiments of the present invention and is not intended to be limiting. Numerous modifications and variations within the scope of the present invention are possible. The present invention is set forth in the accompanying claims.

We claim:

1. A temperature sensing circuit for measuring the resistance of a RTD device having a first terminal and a second terminal, comprising:
a first current source;
a second current source; and
a switch circuit configured, in a first configuration, to connect the first terminal of the RTD device to the first current source and the second terminal of the RTD device to the second current source, and configured, in a second configuration, to connect the second terminal of the RTD device to the first current source and the first terminal of the RTD device to the second current source.

2. The temperature sensing circuit of claim 1, wherein each measurement of the resistance of the RTD device is made with two voltage measurements across the first and second terminals, in which the first voltage measurement has the switch circuit set in the first configuration and the second voltage measurement has the switch circuit set in the second configuration.

3. The temperature sensing circuit of claim 1, wherein the RTD device is connected in series with a sense resistor to ground.

4. The temperature sensing circuit of claim 1, wherein the switch circuit comprises pass transistors.

5. In a temperature sensing circuit, a method for measuring the resistance of a RTD device having a first terminal and a second terminal, comprising:
connecting the first terminal of the RTD device to a first current source and connecting the second terminal of the RTD device to a second current source;
measuring a first voltage across the RTD device;
connecting the second terminal of the RTD device to the first current source and connecting the first terminal of the RTD device to the second current source;
measuring a second voltage across the RTD device; and
deriving the resistance of the RTD device based on the first voltage measurement and the second voltage measurement.

6. The method of claim 5, wherein RTD device is connected in series with a sense resistor to ground.
